(19) United States
(12) Patent Application Publication
(10) Pub. No.: US 2022/0097173 A1
(43) Pub. Date: Mar. 31, 2022

(54) SYSTEM AND METHOD TO CONTROL MATERIAL DEPOSITION USING MAGNETIC FIELDS

(71) Applicant: GM GLOBAL TECHNOLOGY OPERATIONS LLC, Detroit, MI (US)

(72) Inventors: Liang Wang, Rochester Hills, MI (US); Qigui Wang, Rochester Hills, MI (US); Daniel J. Wilson, Linden, MI (US)

(73) Assignee: GM GLOBAL TECHNOLOGY OPERATIONS LLC, Detroit, MI (US)

(21) Appl. No.: 17/035,821

(22) Filed: Sep. 29, 2020

(51) Int. Cl. B23K 26/342; B33Y 10/00; B33Y 30/00; B33Y 50/02; B23K 37/06

(52) U.S. Cl. CPC B23K 26/342; B33Y 10/00; B23K 37/06; B33Y 50/02; B33Y 30/00

(57) ABSTRACT

Systems and methods are provided for controlling additive manufacturing material deposition using a magnetic field. A system may include a build surface; a material depositor through which a magnetically responsive material is deposited on the build surface; an energy source; and a magnet set. The magnet set applies the magnetic field to the build surface and/or to the material depositor. The magnetic field is configured to attract the magnetically responsive material while the energy source melts the magnetically responsive material.

### INTRODUCTION

The present disclosure generally relates to additive manufacturing, and more particularly relates to the application of magnetic fields during particle deposition to improve quality and characteristics of an additive manufactured product, and more specifically, of fusion-based metal additive manufactured products.

Additive manufacturing or 3D printing technologies have come into widespread use due to their desirable qualities such as efficiency and flexibility. One of the challenges in additive manufacturing processes that use technologies such as directed energy deposition or powder bed fusion is controlling porosity. Directed energy deposition creates a product by melting and fusing material particles as they are deposited. Powder bed fusion creates a product by depositing a layer of material and melting and fusing the deposited material particles. As particles are exposed to the presence of the applied energy beam, their movement may be influenced by a number of factors. Influencing factors such as gas flow may cause particles to move in ways that concentrate more in some areas of the product and leave voids in other areas of the product. The precise control of deposited particles is challenging.

In addition to porosity, products produced with directed energy deposition or powder bed fusion may have low resolution and less than optimal material structures. For example, grain structure control is challenging. A “heat affected zone” around the melt pool, is subjected to large thermal gradients. During build, the effects of the temperature gradients on the developing structure are difficult to overcome. In addition, due to the characteristics of fusion-based additive manufacturing, the produced product may be created with an undesirably high level of heterogeneous characteristics in its microstructure and mechanical properties.

Accordingly, it is desirable to provide systems and methods for improved quality and characteristics of an additive manufactured product. Furthermore, other desirable features and characteristics of the present invention will become apparent from the subsequent detailed description and the appended claims, taken in conjunction with the accompanying drawings and the foregoing technical field and background.

### SUMMARY

A number of embodiments include systems and methods for controlling deposited materials using magnetic fields. Embodiments include a system to control additive manufacturing material deposition using a magnetic field, the system. A material depositor delivers a magnetically responsive material for deposited on a build surface. A magnet set applies the magnetic field the build surface and/or to the material depositor. The magnetic field is configured to create an attraction between the magnetically responsive material and the build surface while an energy source melts the magnetically responsive material.

In an additional embodiment, the material depositor includes a material duct, and the magnet set is disposed around the material duct.

In an additional embodiment, the magnet set is disposed around the build surface.

In an additional embodiment, the magnet set includes plural electromagnets.

In an additional embodiment, a controller selectively energizes each one of the plural electromagnets to vary the applied magnetic field.

In an additional embodiment, the controller is configured to control the magnet set in an on and off routine.

In an additional embodiment, the controller is configured to vary an energization level of the magnet set during material deposition.

In an additional embodiment, an actuator is coupled with the magnet set, and the controller is configured to operate the actuator to reposition the magnet set.

In an additional embodiment, the controller suspends the magnetic field while the material depositor deposits the magnetically responsive material.

In an additional embodiment, the energy source is configured to create a melt pool from the magnetically responsive material, and the controller is configured to control the magnet set to direct the magnetic field into the melt pool.

In a number of additional embodiments, a method to control additive manufacturing material deposition using a magnetic field includes depositing a magnetically responsive material and focusing an energy source onto the deposited magnetically responsive material. A magnet set applies the magnetic field to the build surface and/or to the material depositor. A magnetic field creates an attraction between the magnetically responsive material and the build surface, including while the energy source melts the magnetically responsive material.

In an additional embodiment, the material depositor includes a material duct, and the magnet set is disposed around the material duct.

In an additional the magnet set is disposed around the build surface.

In an additional embodiment, the magnet set includes plural electromagnets.

In an additional embodiment, a controller energizes each one of the plural electromagnets to vary the applied magnetic field.

In an additional embodiment, the controller turns the magnet set on and off.

In an additional embodiment, the controller varies an energization level of the magnet set.

In an additional embodiment, the controller repositions the magnet set through an actuator.

In an additional embodiment, the controller suspends the magnetic field while the material depositor deposits the magnetically responsive material.

In a number of additional embodiments, a method to control additive manufacturing material deposition using a magnetic field includes depositing, by a material depositor and onto a build surface, a magnetically responsive material. A controller focuses an energy source onto the deposited magnetically responsive material. A magnet set applies the magnetic field to the build surface and/or to the material depositor. The magnetic field creates an attraction between the magnetically responsive material and the build surface, including while the energy source melts the magnetically responsive material. The controller controls the magnet set to vary the magnetic field to delivery targeted properties in the magnetically responsive material as it solidifies.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic diagram of a system to control material deposition using magnetic fields acting on the build surface of a build plate or a substrate, in accordance with various embodiments;

FIG. 2 is a schematic diagram of a system to control material deposition using magnetic fields acting on a material delivery system, in accordance with various embodiments;

FIG. 3 is a schematic diagram of a system to control material deposition using magnetic fields acting on the build surface of a build plate or a substrate with plural magnetic modules, in accordance with various embodiments;

FIG. 4 is a diagram of a control system for controlling the systems of FIGS. 1-3, in accordance with various embodiments; and

FIG. 5 is a flowchart illustrating a process for building a component using magnetic field controlled material deposition, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of various systems, and that the system described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

As disclosed herein, systems and methods to control deposited materials using magnetic fields as described herein may be used for magnetic assisted additive manufacturing processes and other applications. An in-situ magnetic field is applied during material deposition, such as in directed energy deposition or powder bed fusion. The magnetic field may be applied with permanent magnets and/or with electromagnets. In some embodiments, the magnetic field may be applied to the build surface of a build platform or a substrate, so that the deposited material attaches to the build surface when deposited thereon. In additional embodiments, the material being deposited may be magnetized during the deposition to create an attraction between the build surface and the material. The methods disclosed herein are applicable to various magnetic responsive metal materials.

The applied magnetic field may be controlled during the deposition and post deposition response of the particles and in some embodiments may be cycled on and off to achieve a localized or variable magnetic field in the melt pool. In some embodiments, such as in applications using powder bed fusion, the magnetic field may be suspended during addition of a material layer to the bed to avoid interfering with an even distribution. In some embodiments, such as those that employ nonmagnetic material such as aluminum alloy, a coating or additive may be added to the powder so that it is attracted magnetically. An example of such a coating or additive material may be titanium boron. Various beneficial results may be achieved such as in-situ powder condensation during laser deposition, reduced porosity, refined microstructure, reduced heterogeneous characteristics of the microstructure and mechanical properties, reduce powder waste, controlled deposition orientation and/or others.

As described herein, disclosed methods may include cleaning the substrate and applying a magnetic field to the substrate. The substrate may be a build platform that supports the part during build but is not part of the finished product. Metallic powder is delivered, such as through a nozzle during energy application in some embodiments, or via other application mechanisms that spread a layer such as through rolling of an entire layer before energy application. Flyaway of the magnetic powder is minimized as the metallic powder sticks/attaches onto the substrate as a result of the magnetic field during deposition at locations and orientations that may be determined by the applied magnetic field. Energy, such as from a laser beam, is focused on the substrate/part/powder layer and melts the powder forming a melt pool. In various embodiments, the energy/laser beam is focused on the metallic powder after it is delivered to the substrate to reduce heating effects on the magnetic field. Following completion of a layer of the part being built, the nozzle/energy source is moved up and the part is built up with deposited and fused material layer by layer. As the part is built up, the magnetic field may be reoriented to achieve various results and may be redirected upward close to the top surface (build surface) of the part to maximize its effect on the deposited particles. Multiple magnets may be employed to provide greater granularity for control purposes. Following build of the part to its final dimensions, it may be machined and cleaned as required to meet applicable specifications.

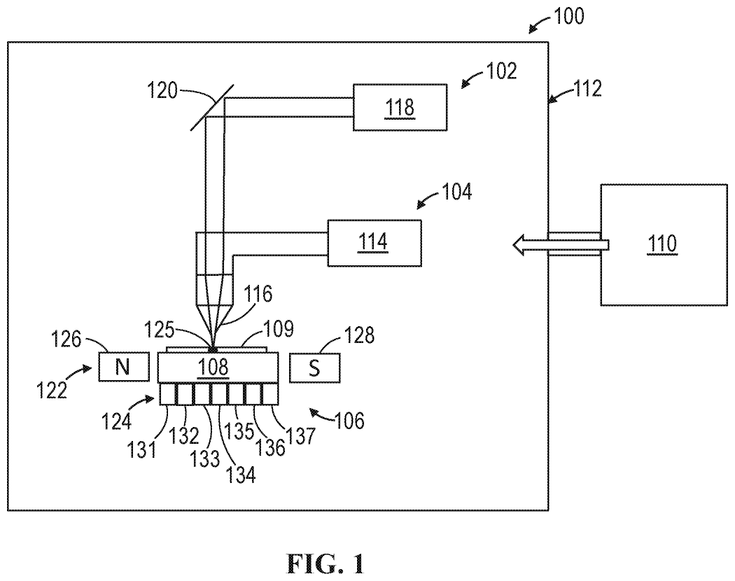

Referring to FIG. 1, a magnetic field controlled material deposition system 100 is schematically illustrated. In general, the magnetic field controlled material deposition system 100 includes an energy delivery system 102 of the laser type, a material depositor in the form of a material deposition system 104, a magnetic field delivery system 106, a build surface in the form of a build platform 108, and a gas delivery system 110 for delivery of an inert gas to a build chamber 112. In the current embodiment the magnetic field controlled material deposition system 100 is illustrated as a directed energy deposition additive manufacturing/3D printing system. In other embodiments other additive manufacturing approaches may be used such as powder bed fusion or others.

In this embodiment, the material deposition system 104 includes a powder supply 114 for delivery of material to a target area through a nozzle 116. The nozzle 116 is moved across the build platform 108 as the part 109 is built one layer at a time. In the current embodiment the power stream is delivered through the same nozzle 116 as the laser beam, such as through at least two concentric passages in the nozzle 116. In other embodiments, the powder stream and the laser beam may be delivered through separate nozzles or conduits. The energy delivery system 102 includes a laser source 118, a mirror 120 for directing the energy, and the nozzle 116 for directing the laser beam. The magnetic field delivery system 106 includes at least one of a permanent magnet set 122 and/or an electromagnet set 124, for magnetizing the build surface of the build platform 108 and/or of the part 109. As such, the build platform 108 is comprised of a magnetizable material such as a ferro-magnetic material. As described in more detail below, the magnetic field may be suspended/removed from the build platform 108 for a number of reasons. Accordingly, the build platform itself may not be a permanent magnet. The build platform 108 comprises a substrate upon which the manufactured part 109 is built and therefore is not a part of the finished product being manufactured. The gas delivery system 110 supplies an inert gas to the sealed build chamber 112 to better control material properties and protect the built-up material of the part 109 from oxidation.

As illustrated in FIG. 1, the magnetic field controlled material deposition system 100 applies a controlled magnetic field to the build platform 108. The permanent magnet set 122 includes a number of permanent magnets/magnet sections 126, 128 to magnetize the build platform 108. In an embodiment, the magnet sections 126, 128 are elements of one magnet structure that encircles the build platform 108. In other embodiments, any number of permanent magnets 126, 128 may be used around the build platform 108. In some embodiments, the permanent magnets 126, 128 may be moved away from the build platform to reduce or eliminate its magnetization and may be moved closer and/or increased in number to increase the magnetic field. The electromagnet set 124 may include any number of individual electromagnets 131-137. In some embodiments only one of the electromagnet 131-137 may be used. In the case of a large sized build platform 108 and/or when more pinpoint magnet field control is desired a greater number of electromagnets 131-137 may be used to cover the entire area of the build platform 108.

In operation, the build chamber 112 is filled with inert gas by the gas delivery system 110. The build platform is selectively magnetized by the magnetic field delivery system 106 supplies a magnetic field via the permanent magnet set 122 and/or the electromagnet set 124. The material deposition system 104 delivers material through the nozzle 116 and the energy delivery system 102 delivers energy through the nozzle 116 to melt the delivered material. This creates a melt pool 125 that fuses as the nozzle 116 is moved away to build the part 109. In general, the magnetic field applied to the build platform 108 and/or instilled in the deposited material particles creates an attraction between the material powder particles and the build plate 108 causing the particles delivered through the nozzle 116 to stick in place on the build platform or on the previously built layer of the part 109. In various embodiments, the magnetic field may be controlled to provide additional effects on the built part 109 as described in more detail below.

In the magnetic field controlled material deposition system 100, the magnetic fields may be used to control porosity in the part 109 being built, thereby improving density. Porosity may form during build such as from incomplete melting of the powder material or improper adhesion of two layers of material. Keyhole porosity may occur when bubbles of gas become entrained in the part 109 during build. Keyhole porosity is characterized by the formation of pores inside the part 109. It has been found that the during build, deposited particles may flow/move within the melt pool 125 created by the laser as a result of the flow of energy leading to increased porosity. The magnetic field attracts the deposited particles and holds them in position within the melt pool 125 reducing porosity. As such, the deposited particles are a ferro-magnetic or other material that is attracted by a magnetic field. In a number of embodiments, the deposited particles comprise aluminum, an aluminum alloy, or another non-ferromagnetic material. In these latter cases, the powder particles are treated, such as by coating, with a magnetically responsive material such as titanium-boron, which the magnetic field will attract and hold in the melt pool 125.

In the magnetic field controlled material deposition system 100, the magnetic fields may be used to refine the microstructure of the material that results in the build part 109. For example, it has been found that in and/or around the melt pool 125 areas of the material may reside in a semi-solid form. If unaddressed, these semi-solid clusters may result in undesirable material characteristic such as heterogeneity. The heterogeneity characteristic has been found to result from semi-solid clusters that reside at the liquid-solid interface and/or within the liquid melt pool. The semi-solid clusters may result in not-equiaxed grains. It has also been found that columnar grain structures may form. Columnar grains are generally undesirable because as they may impart solidification defects and mechanical property anisotropy. The magnetic field may be used to effectively stir or mix the melt pool to break up the semi-solid clusters and columnar grains. This results in a preferred equiaxed grain structure with reduced heterogeneity and red cued columnar grains.

In the magnetic field controlled material deposition system 100, the magnetic fields may be used to reduce fly-away. Fly-away results when particles are blown away from or out of the melt pool 125 and therefore results in a number of undesirable outcomes such as material waste. By holding the deposited particles in position via the magnetic field, fly away is minimized and more of the deposited material is entrained in the part 109 being built.

In the magnetic field controlled material deposition system 100, the magnetic fields may be used to control material deposition orientation. For example, during the build of a complex part 109, such as with out-of-plane sections including projecting angled sections or overhanging cantilevered sections, support structures may typically be built to support the section as it is built layer by layer. These support structures are generally not integral to the design of the part 109 and may be removed in post processing after the additive manufacturing build. The magnetic fields may be directed to help support these section as they are built and therefore may eliminate the need for some or all of the build supports. Because the deposited particles are magnetically responsive, the magnetic field may be used to apply sufficient force to prevent bending or collapse of the sections during build.

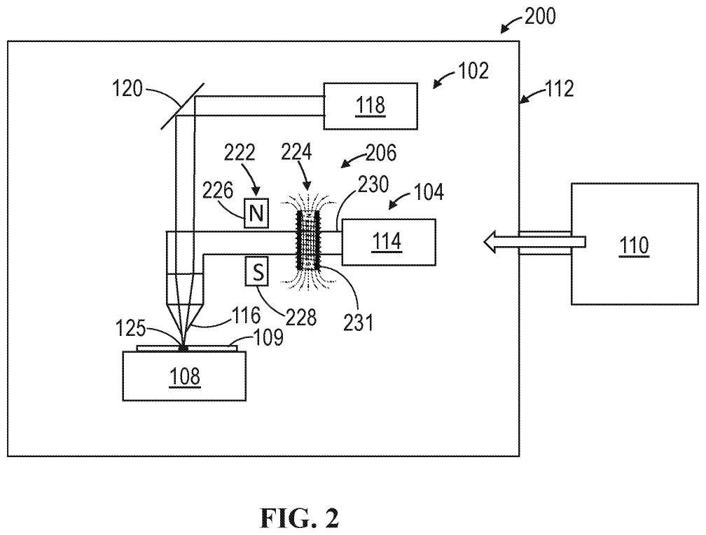

Referring to FIG. 2, a magnetic field controlled material deposition system 200 is schematically illustrated. In general, the magnetic field controlled material deposition system 200 also includes the material deposition system 104, an energy delivery system 102 of the laser type, the build platform 108, and the gas delivery system 110 for delivery of an inert gas to the build chamber 112. In this embodiment the magnetic field controlled material deposition system 200 is also illustrated as a directed energy deposition additive manufacturing/3D printing system. In other embodiments other additive manufacturing approaches may be used such as powder bed fusion or others. In this embodiment a magnetic field delivery system 206 is included.

As illustrated in FIG. 2, a magnetic field controlled material deposition system 200 applies a controlled magnetic field to the material deposition system 104, and specifically to the material particles supplied thereby. The magnetic field delivery system 206 includes at least one of a permanent magnet set 222 and/or an electromagnet set 224. The permanent magnet set 222 includes a number of permanent magnets/magnet sections 226, 228 to magnetize particles supplied by the material deposition system 104 from powder supply 114 through conduits including a duct 230 and the nozzle 116. In an embodiment, the magnet sections 126, 128 are elements of one magnet structure that encircles the duct 230. In other embodiments, any number of permanent magnets 226, 228 may be used around the duct 230. In some embodiments, the permanent magnets 226, 228 may be moved away from the duct 230 to reduce or eliminate its magnetization and may be moved closer and/or increased in number to increase the magnetic field. The electromagnet set 224 may include any number of individual electromagnets 231. In some embodiments one electromagnet 231 may be used. One or more components of the magnetic field delivery system 206, in this embodiment the electromagnet set 224, may be disposed around the powder supply 114. In some embodiments, the electromagnet set 224 may be cycled on and off. In operation, the magnetic field delivery system 206 magnetizes the particles delivered through the nozzle 116 so that they are attracted/stick to the build platform 108 or the previously deposited layer of the part 109 resulting in many of the same desirable outcomes as result in the magnetic field controlled material deposition system 100.

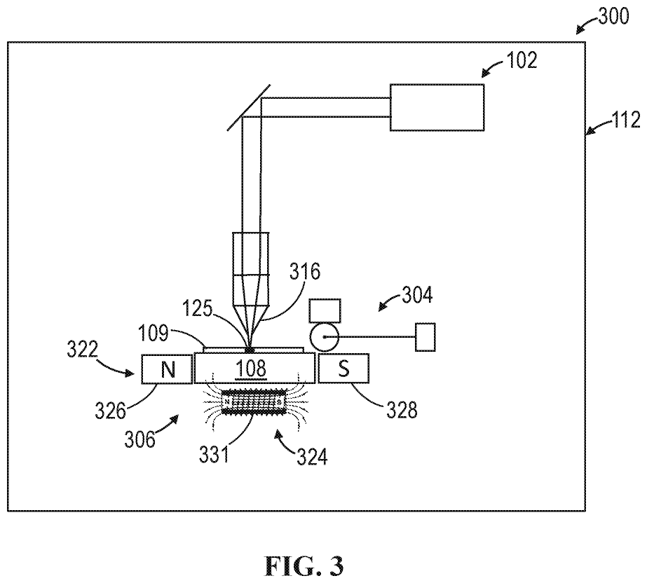

Referring to FIG. 3, a magnetic field controlled material deposition system 300 is schematically illustrated. In general, the magnetic field controlled material deposition system 300 includes a material depositor in the form of a material deposition system 304, the laser type energy delivery system 102, the build platform 108, and the build chamber 112. The material deposition system 304 is configured as a roller system that deposits a layer of material across the build platform 108 prior to application of energy from the laser beam. A gas delivery system (not illustrated) may be included in a number of embodiments. In this embodiment, the nozzle 316 directs the laser beam but not the deposited material. In this embodiment the magnetic field controlled material deposition system 300 is illustrated as a powder bed fusion type additive manufacturing/3D printing system. In other embodiments other additive manufacturing approaches may be used. In this embodiment a magnetic field delivery system 306 is included.

The magnetic field controlled material deposition system 300 applies a controlled magnetic field to the build platform 108. The magnetic field delivery system 306 includes at least one of a permanent magnet set 322 and/or an electromagnet set 324. The permanent magnet set 322 includes a number of permanent magnets/magnet sections 326, 328 to magnetize the build platform 108 and/or the part 109. In an embodiment, the magnet sections 326, 328 are elements of one magnet structure that encircles the build platform 108. In other embodiments, any number of permanent magnets 326, 328 may be used around the build platform 108. The permanent magnets 326, 328 may be moved away from the build platform 108 to reduce or eliminate its magnetization, such as during deposit of a material layer, and may be moved closer and/or increased in number to increase the magnetic field. The electromagnet set 324 may include any number of individual electromagnets 331. In the illustrated embodiment one electromagnet 331 is used. In the case of a large sized build platform 108 and/or when more pinpoint magnet field control is desired a greater number of electromagnets 331 may be used to cover the entire area of the build platform 108. In operation, the magnetic field delivery system 306 magnetizes the build platform 108 so the deposited particles are attracted/stick to the build platform 108 or the previously deposited layer of the part 109 resulting in many of the same desirable outcomes as result in the magnetic field controlled material deposition system 100.

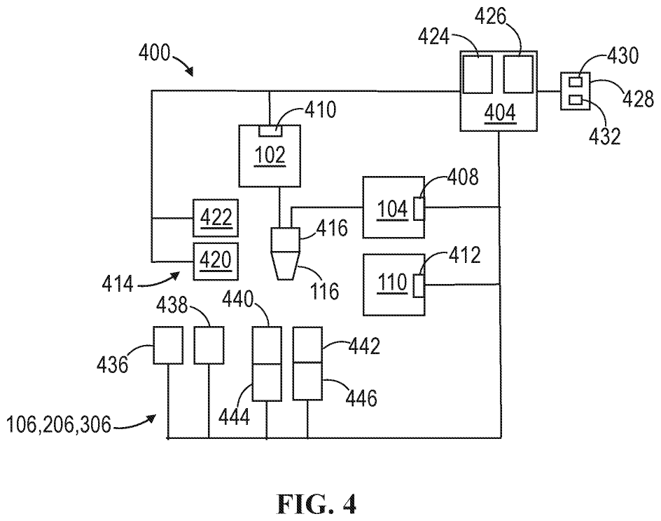

With reference to FIG. 4, control aspects applicable to the magnetic field controlled material deposition systems 100, 200, 300 are illustrated in greater detail in composite form and generally control the energy delivery system 102, the material deposition system 104, the magnetic field delivery system 106, and the gas delivery system 110. The control system 400 includes a controller 404. In other embodiments, any number of controllers may be used in place of the controller 404. For purposes of the current embodiment, the controller 404 controls operation of the magnetic field controlled material deposition systems 100, 200, 300 including of material deposition system 104 by at least one actuator 408, the energy delivery system 102 by at least one actuator 410, and the gas delivery system 110 by at least one actuator 412. In addition, the controller 404 controls aspects of the magnetic field delivery system 106, 206, 306. The controller 404 may also control movement of the nozzle 116 such as by operation of actuator 416. The actuator 416 may be a multi-axis positioning actuator to move the nozzle through various heights, locations and orientations relative to the build platform 108. The controller 404 may comprise any number of electronic control modules and receive various input variables of current operating conditions and other parameters. The inputs are analyzed and operating parameters such as operation of the energy delivery system 102, the magnetic field delivery system 106, 206, 306, and others are computed from the data and applied to the various actuators and other responsive devices as appropriate. The controller 404 may receive various signals, including from a sensor suite 414, conduct analyses, and send control signals to various destinations, including to the actuators 408, 410, 412, 416 and the magnetic field delivery system 106, 206, 306. The sensor suite 414 may sense various aspects of the part 109 and its build including detecting the height of the build to determine the location of the current build surface through a position sensor 420, and the location of the nozzle 116 through position sensor 422. The sensor suite 414 may include any number of additional sensors to monitor the part 109 and operation/status of the magnetic field controlled material deposition systems 100, 200, 300.

The controller 404 may comprise any number of electronic control modules. The controller 404 receives information from various sources, process that information, and provides control signals/commands based thereon to effect operation of the magnetic field controlled material deposition systems 100, 200, 300. The controller 404 includes a processor 424 and a memory device 426, and is coupled with a storage device 428. The processor 424 performs the computation and control functions of the controller 404 and during operation executes one or more programs 430 and may use data 432, each of which may be contained within the storage device 428 and as such, the processor 424 controls the general operation of the controller 404 in executing the processes described herein, such as the processes described further below. The memory device 426 may be any type of suitable memory or combination of memory devices capable of storing data, some of which represent executable instructions, used by the controller 404. In the illustrated embodiment, the memory device 426 may store the above-referenced programs 430 along with one or more stored values of the data 432 such as for short-term data access. The storage device 428 stores data, such as for long-term data access for use in automatically controlling the magnetic field controlled material deposition systems 100, 200, 300 and may be any suitable type of storage apparatus. In an exemplary embodiment, the storage device 428 comprises a source from which the memory device 426 receives the programs 430 and data 432. The programs 430 represent executable instructions, used by the controller 404 in processing information and in controlling the magnetic field controlled material deposition systems 100, 200, 300, including the magnetic field delivery system 106, 206, 306. The processor 424 may generate control signals for the magnetic field delivery system 106, 206, 306 based on the logic, calculations, methods, and/or algorithms.

As the build progresses, powder to build the part 109 is deposited in individual layers on the build platform 108 and the energy delivery system 102 selectively energizes the powder to form the part 109 according to its design parameters. The magnetic field delivery system 106, 206, 306 may be actuated after material is deposited on the build or while the depositing is taking place. The timing for which the magnetic field delivery system 106, 206, 306 is actuated may be predefined and stored in memory and may be recalled according to parameters such as the height of the build as sensed by the position sensor 420.

The magnetic field delivery system 106, 206, 306 may include any number of electromagnets, such as electromagnets 436, 438, which are representative of the electromagnets of FIGS. 1-3. The electromagnets 436, 438 may be energized and deenergized to provide magnetic fields of varying intensity and direction or to provide no magnetic field. The magnetic field delivery system 106, 206, 306 may include any number of permanent magnets 440, 442, which are representative of the permanent magnets of FIGS. 1-3. As illustrated in FIG. 4, the permanent magnets are mounted to be repositionable by actuators 444, 446, respectively. The actuators 444, 446 may be a multi-axis positioning actuators to move the permanent magnets 440, 442 through various locations to vary or eliminate the applied magnetic field as described below in more detail. The controller 404 may receive various signals, including from a sensor suite 414, conduct analyses, and send control signals to the actuators 444, 446. The controller 404 may control the magnetic field delivery system 106, 206, 306 to vary the generated magnetic field including to direct the magnetic field into the melt pool 125.

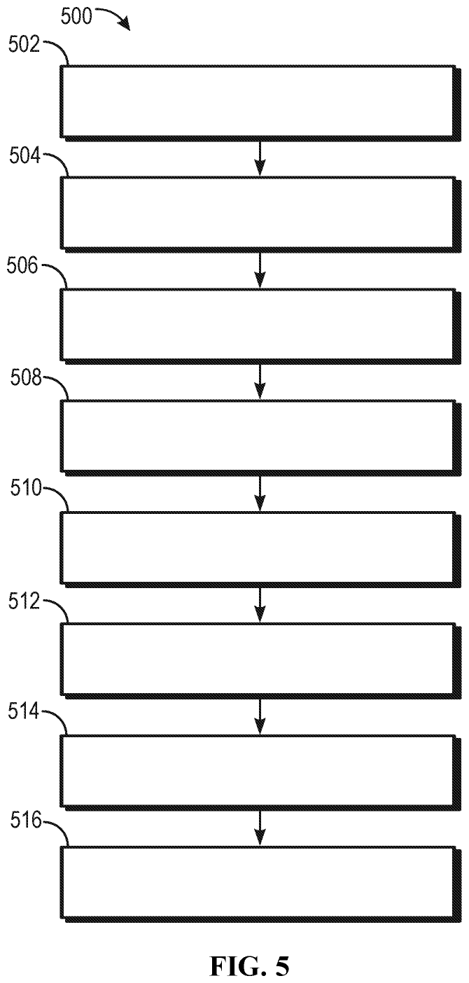

Referring to FIG. 5, a process 500 is illustrated, which may be carried out using at least one of the magnetic field controlled material deposition systems 100, 200, 300. The process 500 begins with preparing 502 the build platform 108 and otherwise setting up the additive manufacturing machine. For example, residue from a previous build is machined off and the build platform 108 is cleaned presenting a fresh build surface in preparation for building a new part or parts 109. The process 500 includes the select application 504 of a magnetic field such as by one of the magnetic field delivery systems 106, 206, 306. The application 504 may entail energizing the electromagnet set 124, 224, 324 either completely or partially. The application 504 may entail moving the permanent magnet set 122, 222, 322 into position when equipped with actuators 444, 446. The process 500 includes the delivery 506 of powder to the build platform 108 or to the previously built layer of the part 109, such as by the material deposition system 104, 304. The application 504 may precede the delivery 506 or the delivery 506 may precede the application 504, or the two may be initiated simultaneously. For example with a directed energy deposition system, the application 504 of the magnetic field may precede the delivery 506 of powder by a short time interval, or the two may be initiated simultaneously. In another example, such as in the case of a powder bed fusion application, the delivery 506 of a powder layer across the build platform 108 may precede the application 504 to enable a uniform distribution of the deposited layer.

The process 500 includes control 508 of the magnetic field such as by the controller 404, which may be ongoing throughout the build stages. For example, in the case of multiple electromagnets 131-137, less than all of the electromagnets 131-137 may be energized at any particular time. This approach may be employed when a large part 109 is being built and only the electromagnet(s) 131-137 in the area of the build platform 108 where the nozzle 116 is currently operating may be energized. This approach may also be employed to concentrate the magnetic field in the melt pool 125. In another example, the individual electromagnets 131-131 may be energized or varied in energization level for material deposition orientation such as to support features of the part 109 being built. In another example, the individual electromagnets 131-131 may be energized or varied in energization to mix/stir the melt pool 125 such as to break up columnar grains and/or semi-solid clusters. In another example, the magnetic field may be suspended during application of a material layer such as with powder bed fusion builds.

The process 500 includes focusing 510 the energy beam on the build surface of the build plate 108 or of the elevated level of the part 109 being built to melt the delivered 506 powder, such as during or after deposition. In an embodiment, the focusing 510 may be delayed until after the delivery 506 of the powder to reduce heating effects on the magnetic field. For example, the heat applied by the energy delivery system 102 may be intense enough to distort or weaken the magnetic field over a prolonged period.

Following completion of a layer of the part 109 being built, the process 500 includes positioning the nozzle 116. For example, the nozzle 116 is elevated such as by the control system 400, and positioned at a designated start point in preparation to build the next layer of the part 109. The process may return to the select application 504 of magnetic field and may cycle through steps 504-512 as the part 109 is built to its design dimensions layer-by-layer. As the part 109 is built up the magnetic field moves up close to the upper surface of the in-process part 109. For example, the magnetic field may be conducted through the build platform 108 and the part 109. In another example, the energization level of the electromagnet set 124, 224, 324 may be increased, such as by the control system 400, as the height of the part 109 increases. In another example, the magnets may be moved up, such as by the control system 400 and the actuators 444, 446. When the part 109 is fully built, post processing 516 is conducted. The post processing 516 may include removal of the part 109 from the build platform 108, along with any required machining and/or cleaning and the part 109 is complete.

Through the embodiments disclosed herein, magnetic fields are used to control deposited materials during additive manufacturing processes. The magnetic fields advantageously enable reducing porosity, refining the material microstructure of the part, reducing heterogeneous characteristics, reducing fly away to reduce powder use rates, and/or to control deposition orientation. While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes may be made in the function and arrangement of elements and/or steps without departing from the scope of the disclosure as set forth in the appended claims and the legal equivalents thereof.

What is claimed is:

1. A system to control additive manufacturing material deposition using a magnetic field, the system comprising:
a build surface;
a material depositor through which a magnetically responsive material is deposited on the build surface;
an energy source; and
a magnet set, wherein the magnet set is configured to apply the magnetic field to at least one of the build surface and the material depositor,
wherein the magnetic field is configured to create an attraction between the magnetically responsive material and the build surface, including while the energy source melts the magnetically responsive material.

2. The system of claim 1, wherein the material depositor includes a material duct, and wherein the magnet set is disposed around the material duct.

3. The system of claim 1, wherein the magnet set is disposed around the build surface.

4. The system of claim 1, wherein the magnet set includes plural electromagnets.

5. The system of claim 4, comprising a controller, wherein the controller is configured to selectively energize each one of the plural electromagnets to vary the applied magnetic field.

6. The system of claim 1, comprising a controller, wherein the controller is configured to control the magnet set in an on and off routine.

7. The system of claim 6, wherein the controller is configured to vary an energization level of the magnet set.

8. The system of claim 6, comprising at least one actuator on the magnet set, wherein the controller is configured to operate the actuator to reposition the magnet set.

9. The system of claim 1, comprising a controller, wherein the controller is configured to suspend the magnetic field while the material depositor deposits the magnetically responsive material.

10. The system of claim 1, wherein the energy source is configured to create a melt pool from the magnetically responsive material, and comprising a controller configured to control the magnet set to direct the magnetic field into the melt pool.

11. A method to control additive manufacturing material deposition using a magnetic field, the method comprising:
depositing, through a material depositor and onto a build surface, a magnetically responsive material;
focusing an energy source onto the deposited magnetically responsive material;
applying, by a magnet set, the magnetic field to at least one of the build surface and the material depositor; and
creating an attraction, by the magnetic field, between the magnetically responsive material and the build surface, including while the energy source melts the magnetically responsive material.

12. The method of claim 11, wherein the material depositor includes a material duct, and comprising positioning the magnet set around the material duct.

13. The method of claim 11, comprising positioning the magnet set around the build surface.

14. The method of claim 11, comprising providing the magnet set as plural electromagnets.

15. The method of claim 14, comprising energizing, by a controller, each one of the plural electromagnets to vary the applied magnetic field.

16. The method of claim 11, comprising controlling, by a controller, the magnet set.

17. The method of claim 16, comprising varying, by the controller, an energization level of the magnet set.

18. The method of claim 16, comprising repositioning, by the controller via an actuator, the magnet set.

19. The method of claim 11, comprising suspending, by a controller, the magnetic field while the material depositor deposits the magnetically responsive material.

20. A method to control additive manufacturing material deposition using a magnetic field, the method comprising:
depositing, through a material depositor and onto a build surface, a magnetically responsive material;
focusing, by a controller, an energy source onto the deposited magnetically responsive material;
applying, by a magnet set, the magnetic field to at least one of the build surface and the material depositor;
creating an attraction, by the magnetic field, between the magnetically responsive material and the build surface, including while the energy source melts the magnetically responsive material;
varying, by the controller controlling the magnet set, the magnetic field to deliver targeted properties in the magnetically responsive material as it solidifies.
